(19) United States
(12) Patent Application Publication
(10) Pub. No.: US 2015/0081473 A1
(43) Pub. Date: Mar. 19, 2015

(54) SMART SOCIAL GIFTING

(71) Applicant: International Business Machines Corporation, Armonk, NY (US)

(72) Inventors: Joanna W. Ng, Unionville (CA); Diana Lau, Richmond Hill (CA)

(21) Appl. No.: 14/315,868

(22) Filed: Jun. 26, 2014

Related U.S. Application Data
(63) Continuation of application No. 14/026,571, filed on Sep. 13, 2013.

(51) Int. Cl. G06Q 30/06; G06Q 50/00; G06Q 20/10

(52) U.S. Cl. CPC G06Q 30/0631; G06Q 20/10; G06Q 50/01
USPC 705/26.7; 705/39

(57) ABSTRACT

In a method for utilizing social networking services of a user to perform online retail services, a processor retrieves a set of contacts, wherein the set of contacts includes a first group of contacts of a first networking service and a second group of contacts of a second networking service, wherein each contact in the set of contacts has a corresponding link to information about that contact. A processor receives a request for an action to be executed, wherein the request includes gifting information, wherein the gifting information specifies a required relationship between the user and the one or more contact of the set of contacts. A processor determines the one or more contacts that have the required relationship with the user, as specified by the gifting information. A processor causes the action to be executed based on the determined one or more contacts.

### FIELD OF THE INVENTION

The present invention relates generally to the field of online retail services, and more particularly to performing social commerce and social gifting actions using interoperable social networking services.

### BACKGROUND OF THE INVENTION

Online retail is a form of electronic commerce, which allows consumers to directly buy goods or services from a seller over the Internet using a web browser. Online retail provides added benefits and information to customers, such as increased information, customer reviews, competitive pricing, and typically broader selections. Many companies that engage in online retail have algorithms that offer recommendations or suggestions to consumers based upon previously viewed or purchased items.

Social commerce is the use of one or more social networks in the context of online retail transactions. Social commerce is a subset of electronic commerce that involves using social media and user contributions to assist in the online buying and selling of products and services. Social commerce may include customer ratings and reviews or user recommendations and referrals.

Online social networks are well known, and examples include LinkedIn®, Google+®, Facebook®, and various additional online social utilities that support social networking. Such social networks can grow as their numbers discover and connect with other people who have similar interests or experiences.

Social networks track and enable connections between their members (including people, businesses, and other entities). In particular, social networking websites allow their members to efficiently communicate information that is relevant to friends or other connections on the social network. Social networks typically incorporate a system for maintaining connections among members in the social network and for maintaining links to content that is likely to be relevant to the members. Social networks also connect and maintain information about their members. This information may be substantially static, such as employer, job type, age, music preferences, interests, and a variety of other attributes, or it may be more dynamic, such as a member's geographic location within a city, or his or her actions within the social network.

A typical modern computer-implemented social networking application allows each member to provide some biographical and contact information, to identify his or her interests, and to make social networking posts about his or her status and daily life. Social networks can also suggest to the member other members whom the user might know, or other members with compatible interests.

Typically, when a member of a social network wishes to share information with other members of the social network, the member uploads or copies and pastes the information to a location on the social network as a social networking post, or sends the information in the form of a private message or email to other members.

An ontology formally represents knowledge as a set of concepts within a domain, and the relationships between pairs of concepts. An ontology provides a shared vocabulary, which can be used to model a domain, that is, the type of objects and/or concepts that exist, and their properties and relations. Ontologies create a structural framework for organizing information and are used in artificial intelligence, the semantic web, and other areas as a form of knowledge representation about the world or some part of it.

The semantic web is a standard that promotes common data formats on the internet. The semantic web provides a common framework that allows data to be shared and reused across application, enterprise, and community boundary. The semantic web involves publishing in languages specifically designed for data: Resource Description Framework (RDF, Web Ontology Language (OWL), and Extensible Markup Language (XML). HTML describes documents and the links between them. RDF, OWL, and XML, by contract, can describe arbitrary things such as people, meetings, or parts of an object or assembly. Machine-readable descriptions enable content managers to add meaning to content, i.e., to describe the structure of the knowledge we have about content. In this way, a machine can process knowledge itself, instead of text, using processes similar to human deductive reasoning and inference, thereby obtaining more meaningful results and helping computers to perform automated information gathering and research.

Current implementations of social commerce develop social commerce through mutual agreements between the online retailer and the social networking platform. Social commerce capabilities are dictated by such agreements according to respective interests of each party.

Today, online shoppers engaging in social commerce manually maintain and manage their contact list outside of the online retailer site, typically doing so within the confines of their applicable social network. As online shoppers engage in social commerce and perform online gifting, they manually copy/type the email address or profile of each contact, one at a time.

### SUMMARY

Aspects of an embodiment of the present invention disclose a method, computer program product, and computing system for utilizing social networking services of a user to perform online retail services. A processor retrieves a set of contacts, wherein the set of contacts includes a first group of contacts of a first networking service and a second group of contacts of a second networking service, wherein each contact in the set of contacts has a corresponding link to information about that contact. A processor receives a request for an action to be executed, wherein the request includes gifting information, wherein the gifting information specifies a required relationship between the user and the one or more contact of the set of contacts. A processor determines the one or more contacts that have the required relationship with the user, as specified by the gifting information. A processor causes the action to be executed based on the determined one or more contacts.

### BRIEF DESCRIPTION OF THE SEVERAL VIEWS OF THE DRAWINGS

FIG. 1 depicts a diagram of a computing system in accordance with one embodiment of the present invention.

FIG. 2A depicts a diagram of interoperable social services 120 in accordance with one embodiment of the present invention.

FIG. 2B depicts a diagram of social gifting services 140 in accordance with one embodiment of the present invention.

FIG. 3 depicts a flowchart of the steps of a social services program executing a contact aggregation function within the computing system of FIG. 1, for retrieving contacts from one or more sources, and merging profiles directed toward the same contact.

FIG. 4 depicts a flowchart of the steps of a social services program executing a relationship association function within the computing system of FIG. 1, for establishing relationships between contacts, and performing service actions using contact information, established relationships, and inferences based on established relationships.

FIG. 5 depicts a flowchart of the steps of a gifting occasion function within the computing system of FIG. 1, for sending reminders and recommendations to a user at or around potential gift giving occasions.

FIG. 6 is an exemplary user interface window to a relationship association function in accordance with one embodiment of the present invention.

FIG. 7 is an exemplary user interface window of a retail website with access to interoperable social services 120 and social gifting services 140 for submitting a purchase.

FIG. 8 is an exemplary user interface window of a retail website with access to interoperable social services 120 and social gifting services 140 for finalizing an order.

FIG. 9A is an exemplary user interface window of a retail website with access to interoperable social services 120 and social gifting services 140 for inputting gifting occasion reminder and preference information.

FIG. 9B is an exemplary user interface window of a retail website with access to interoperable social services 120 and social gifting services 140 for inputting gifting occasion reminder and preference information.

FIG. 10 depicts a block diagram of components of the client computing device, internet service provider (ISP)/telecommunications server, social networking server, and server of FIG. 1 in accordance with one embodiment of the present invention.

### DETAILED DESCRIPTION

The present invention provides a method and system for social gifting services for online commerce sites that can be configured and executed using established relationships with contacts that are interoperable across multiple social networking platforms. In addition, social gifting services, such as social gifting services 140, can be used to enhance retail services, such as retail services 130, to cause more relevant reminders and marketing promotions to users for potential gift giving occasions based upon facts about established relationship(s) and/or for seasonal events.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The present invention will now be described in detail with reference to the Figures.

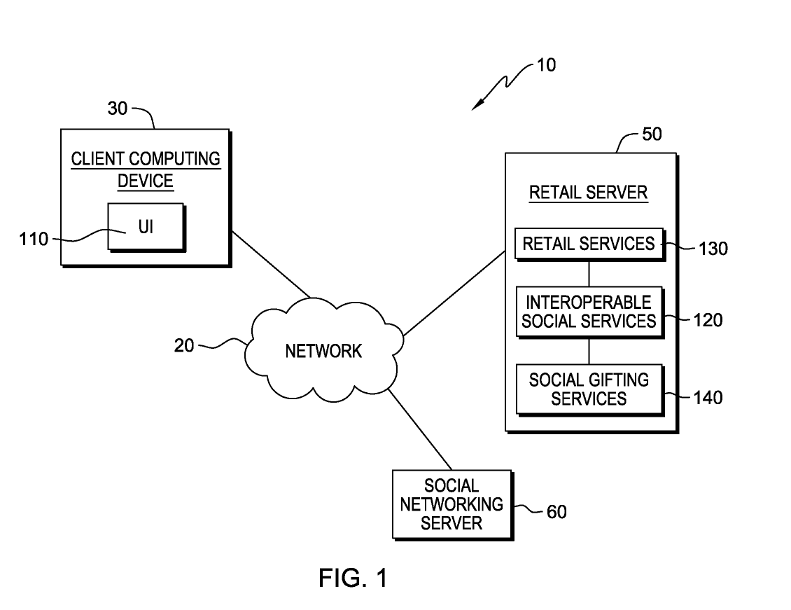

FIG. 1 depicts a diagram of computing system 10 in accordance with one embodiment of the present invention. FIG. 1 provides only an illustration of one embodiment and does not imply any limitations with regard to the environments in which different embodiments may be implemented.

In the depicted embodiment, computing system 10 includes client computing device 30, retail server 50, and social networking server 60 interconnected over network 20. Network 20 may be a local area network (LAN), a wide area network (WAN) such as the Internet, a cellular data network, any combination thereof, or any combination of connections and protocols that will support communication between client computing device 30, retail server 50, and/or social networking server 60 in accordance with embodiments of the invention. Network 20 may include wired, wireless, or fiber optic connections. Computing system 10 may include additional computing devices, servers, computers, or other devices not shown.

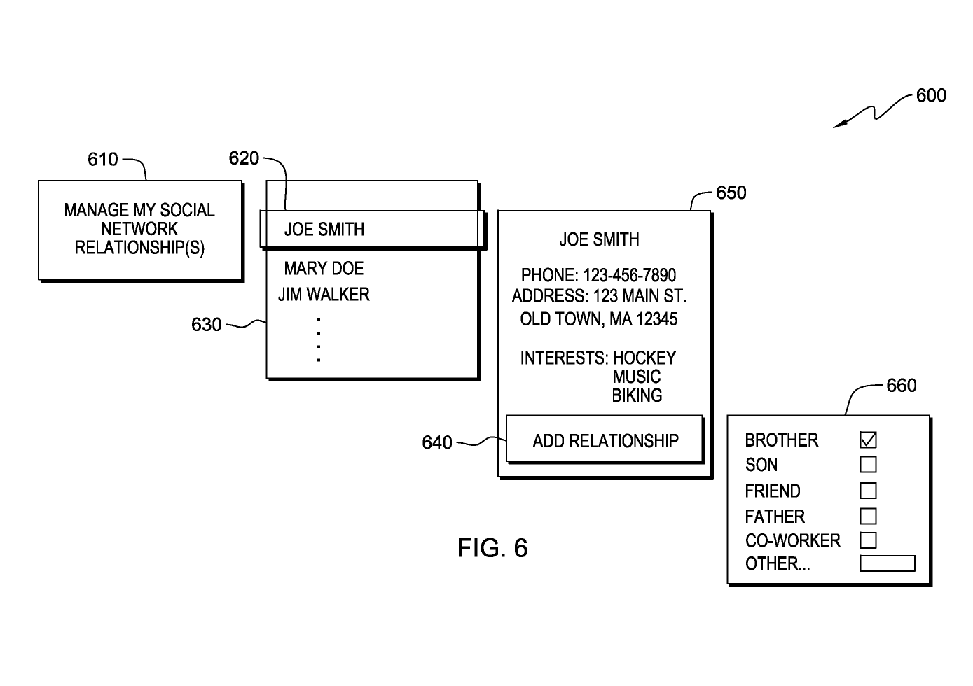

Client computing device 30 may be a desktop computer, laptop computer, netbook computer, tablet computer, personal digital assistant (PDA), or smart phone. In general, client computing device 30 may be any electronic device or computing system capable of sending and receiving data, and communicating with retail server 50, and/or social networking server 60 over network 20. Client computing device 30 contains user interface (UI) 110. Client computing device 30 may include components, as depicted and described in further detail with respect to FIG. 6.

Retail server 50 may be a management server, a web server, or any other electronic device or computing system capable of sending and receiving data and communicating with client computing device 30, and social networking server 60 via network 20. In some embodiments, retail server 50 may represent a server computing system utilizing multiple computers as a server system, such as in a cloud computing environment. Retail server 50 may be an enterprise server capable of providing retail services to a large number of users. Retail server 50 contains retail services 130, interoperable social services 120, and social gifting services 140. Retail server 50 may include components, as depicted and described in further detail with respect to FIG. 6.

Social networking server 60 may be a management server, a web server, or any other electronic device capable of receiving and sending data. In another embodiment, social networking server 60 may represent a server computing system utilizing multiple computers as a server system, such as in a cloud computing environment. Social networking server 60 may host a social networking platform, professional networking platform, email service, or contact list capable of providing contact information or other information about a “friend,” or other social networking connection. In one embodiment, social networking server 60 may be a server for a social networking company that provides social network users with an ability to establish connections with other users of the same social network. Connected users may be able to view contact, interest, relationship, employment, or other information that is shared with the user by each respective connection.

UI 110 operates on client computing device 30 to visualize content from interoperable social services 120, retail services 130, and social gifting services 140. UI 110 allows a user to view and input information in order to allow the user to take advantage of the services provided by interoperable social services 120, retail services 130, social gifting services 140, and other services not shown. UI 110 may include one or more interfaces such as an operating system interface and one or more application interfaces. In one embodiment, UI 110 communicates with interoperable social services 120, retail services 130, and social gifting services 140 through one or more application interfaces. In another embodiment, UI 110 may reside on another electronic device or computing system, provided that UI 110 can communicate with interoperable social services 120, retail services 130, and social gifting services 140.

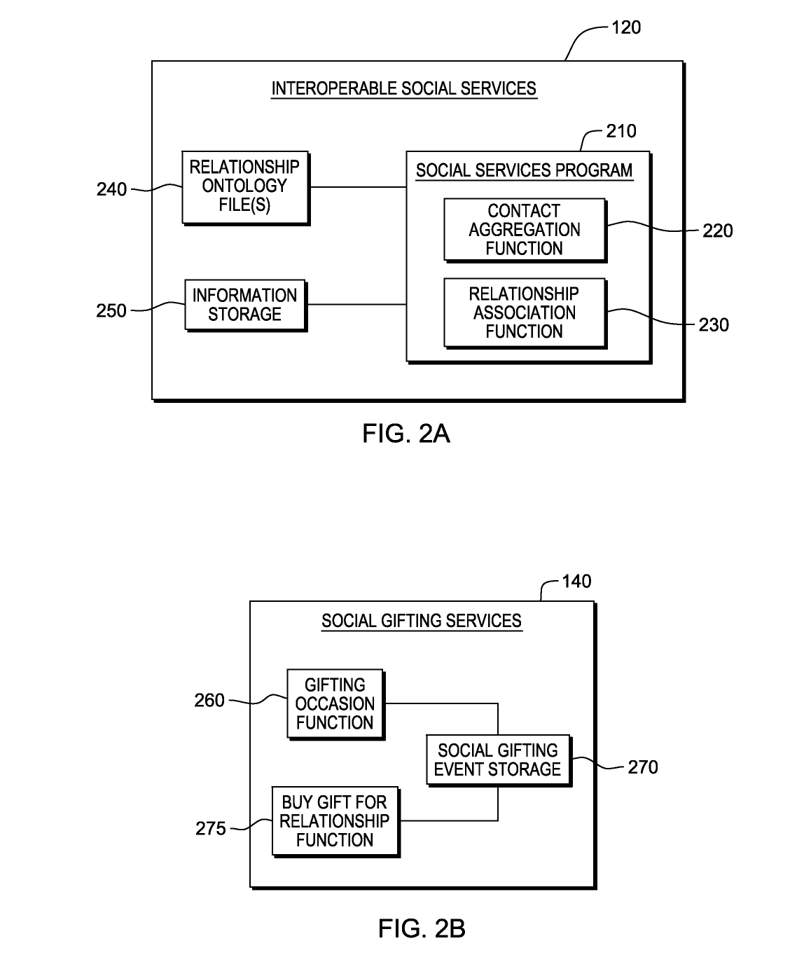

Interoperable social services 120 is a set of software and/or hardware components that may be installed to or otherwise included within a server, such as retail server 50. Interoperable social services 120 operates to access social networking contact information, retrieve contact information, combine contacts from multiple social network platforms into a single contact aggregate that represents a single identity, associate relationships with contact aggregates, and allow for retail services, such as retail services 130, and social gifting services 140 to access and use this information. Information that will typically be used by retail services 130 and social gifting services 140 includes the social network of relationships and contacts; the facts retrieved, such as preferences for gifts; special dates for the contact such as birthdays; special dates for the contact based upon associated relationships between the user and contact (e.g. user needs to buy gift for spouse for wedding anniversary); and others, to better perform retail services for a user. A contact aggregate contains one or more entries from social networks of a user, such as social networking server 60, that represent a single unique individual contact. For example, an individual contact may have profiles on two social networks, and the contact aggregate for that individual will contain information from each social network within the single contact aggregate. Retail services, such as retail services 130 may include services such as enhancing gift promotion/recommendation timing and suggestions, automatic reminders for users to buy gifts for important people for important occasions, as well as other online shopping services. Interoperable social services 120 also operates to store information relevant to gift giving and gift giving occasions, and causes reminders and recommendations to be sent about stored gift giving occasions and inferred potential gift giving occasions. In the current embodiment, interoperable social services 120 resides on retail server 50. Interoperable social services 120 may be interoperable among different web sites and platforms, provided the necessary hardware and/or components (i.e., substantially similar duplicates of interoperable social services 120) are installed or accessible by the respective platform. Interoperable social services 120 will be discussed in further detail with regards to FIG. 2.

Retail services 130 operate to provide retail services to users who access retail server 50. Retail services may include buying and selling goods and services, saving items on an online shopping cart, creating and sharing wish lists, browsing products, reviewing products, viewing generated recommendations, tracking shipped packages, targeting marketing and promotions, or performing other similar actions or services. In other embodiments, services beyond the scope of online retail may similarly interact with interoperable social services 120. For example, retail server 50 may be an email server, and retail services 130 may include sending and receiving emails, importing and exporting contact lists, managing appointments on a calendar, and other related services. In general, retail services 130 may include any retail-related actions or services provided by a retailer or seller of goods or services to a user, such as a user at client computing device 30. In one embodiment, retail services 130 reside on retail server 50. In other embodiments, retail services 130 may reside on another server or another computing device, provided that retail services 130 is accessible to client computing device 30 through UI 110 and interoperable social services 120, and provided that retail services 130 has access to interoperable social services 120.

Retail services 130, for example but not limited to, promotion services, can look up social gifting events registered in social gifting event storage 270 for targeted promotions and recommendations. New services such as gift reminders can be added to retail services 130, by reading registered social gifting events stored to social gifting event storage 270. In one embodiment, gifting occasion function 260 may access gifting events stored to social gifting event storage 270 and cause promotion and recommendation services to be performed.

Social gifting services 140 is a set of software and/or hardware components that may be installed to or otherwise included within a server, such as retail server 50. Social gifting services 140 operates to allow a purchaser who has selected an item to purchase, to specify a relationship axiom corresponding to one or more contacts or contact aggregates for whom to purchase the item. Social Gifting Services 140 also operates to allow purchaser to set up gifting conditions based on facts and/or relationships associated with the relationship. An exemplary embodiment of social gifting services 140 contains user interfaces that allow a purchaser to set up gifting reminders for both seasonal gifting occasions (e.g., Valentines Day, Christmas, Hanukkah) and relational gifting occasions (e.g., sibling(s), spouse, parents).

FIG. 2A depicts a diagram of interoperable social services 120 in accordance with one embodiment of the present invention. In the depicted embodiment, interoperable social services 120 resides on retail server 50. FIG. 2A provides an illustration of one embodiment and does not imply any limitations with regard to the environments in which different embodiments may be implemented.

In the depicted embodiment, interoperable social services 120 includes social services program 210, contact aggregation function 220, relationship association function 230, relationship ontology file(s) 240, and information storage 250. As previously mentioned, interoperable social services 120 may include additional components and software.

Social services program 210 operates to access social networking contact information, combine contacts from multiple social network accounts into a single contact aggregate by maintaining links to all facts about the contact from each applicable social networking platform. Social services program 210 enables the association of one or more relationships between the user and one or more contact aggregates, or alternatively, between a contact aggregate and one or more different contact aggregates. Social services program 210 may also allow retail server 50 to access and use information from applicable social networking platforms of the respective contact to better perform social gifting services 140 or other retail services, such as retail services 130, for a user. Retail services, such as retail services 130, may be any of the retail services discussed in FIG. 1, such as buying or selling goods, creating wish lists, viewing and reviewing products, etc.

In one embodiment, social services program 210 includes two functions: contact aggregation function 220 and relationship association function 230. In one embodiment, social services program 210 resides on the retail server containing the retail services, such as retail services 130, that it assists. In other embodiments, social services program 210 may reside on another server, or another computing device, provided that social services program 210 is accessible to social gifting services 140, applicable enterprise services, such as enterprise services 130, and provided that social services program 210 has access to respective relationship ontology file(s) 240, information storage 250, social gifting services 140, and applicable enterprise services.

Contact aggregation function 220 operates to retrieve information from and allow access to contact and/or user profile information stored within a variety of social media, email, and other similar connection-making platforms. In one embodiment, contact aggregation function 220 may merge contact or profile information from multiple sources into a single contact aggregate, according to a set of contact reconciliation rules. In one embodiment, contact aggregation function 220 may be integrated within retail services, such as retail services 130, such that contact aggregation function 220 may operate within the user interface of the webpage, application, or platform design. In one embodiment, contact reconciliation rules may be predefined or may be customizable by a user through UI 110 on client computing device 30. In another embodiment, contact aggregation function 220 may alert and query a user at client computing device 30, through UI 110 as to retrieved contact information and profile information from multiple contact sources that may in fact be directed to the same user. For example, a person may have a profile on a first social networking platform and a profile on a second social networking platform. Contact aggregation function 220 may allow a user to designate primary message settings for each user.

Relationship association function 230 operates to assist retail services 130 in the performance of retail services in response to received queries, using relationship ontology and user profile extracted information. In one embodiment, relationship association function 230 may be able to make inferences based on relationship information obtained from user profiles or input by a user. For instance, a “manage my social network” tab may exist on the web site of an online retailer that has access to interoperable social services 120, and a user may be able to write-in or select one or more relationships between the user and the contact, as well as relationships between two or more contacts. Relationship association function 230 may also be able to import or export contacts containing user profile information to and from other retail and enterprise servers equipped with interoperable social services 120 or substantially similar duplicates thereof. Relationship association function 230 may be able to help retail services 130 perform retail services using information retrieved, created and stored during the execution of contact aggregation function 220.

Relationship association function 230 may also allow a user to designate one or more relationships between the user and other contacts, as well as between multiple contacts of the user. Relationships a user can designate may include familial (e.g., brother, parent, cousin), employment (e.g., boss, co-worker), service (e.g., barber, electrician), geographic (e.g., neighbor, location of residence), interest (e.g., hobby, favorite sports team), friendship-level (e.g., friend, acquaintance, significant other), or other types of relationships. Defined relationships, along with user profile information, links to user profile information, and other retrieved data may be stored to information storage 250. Such information may be stored in a format that is interoperable between systems equipped with interoperable social services, such as interoperable social services 120 on retail server 50. In one embodiment, the information may be stored in the resource description framework (RDF) as an extensible markup language (XML) file. RDF is a general method for conceptual description or modeling of information that is implemented in web resources. XML is a markup language that defines a set of rules for encoding documents in a format that is both human-readable and machine-readable.

Information storage 250 is a repository that may be written and read by social services program 210, contact aggregation function 220, and relationship association function 230. User profile graph objects, extracted user profile information, defined relationships and/or links to user profile information may be stored to information storage 250. In addition, contact reconciliation rules may be stored to information storage 250. In one embodiment, information storage resides with interoperable social services 120. In other embodiments, information storage 250 may reside on another server or another computing device, provided that information storage 250 is accessible to social services program 210, contact aggregation function 220, relationship association function 230, social gifting services 140, and applicable retail services, such as retail services 130.

Relationship ontology file(s) 240 is a repository that may be written and read by social services program 210 and relationship association function 230. Relationship ontology information may be stored to one or more relationship ontology file(s) 240. In one embodiment, relationship ontology information is stored as one or more web ontology language (OWL) files. OWL files are a type of file used by knowledge representation languages for authoring ontologies. The OWL file-type is characterized by formal semantics and RDF/XML-based serializations for the semantic web. Relationship ontology information may contain facts, classes, subclasses, and other information that define something. For instance, “mother” may be characterized by one or more combinations of the fact that a person “has a child,” “is female,” “is not male,” or “is a parent.” Relationship ontology information may help relationship association function 230 decipher inferences and recognize extended relationships based upon relationship information retrieved and input by a user. Relationship ontology file(s) 240 may comprise one or more files, and enterprise servers may utilize one or more relationship ontology file(s) 240, based on the needs of the services being performed, such as retail services 130. In one embodiment, relationship ontology file(s) 240 resides with the other files and components of interoperable social services 120 on retail server 50. In other embodiments, relationship ontology file(s) 240 may reside on another server or another computing device, provided that relationship ontology file(s) 240 is accessible to social services program 210, relationship association function 230, and gifting occasion function 260. In yet other embodiments, relationship ontology file(s) 240 may be uniform resource locator (URL) addressable for access by any user or entity with knowledge of the particular URL and access to the internet.

FIG. 2B depicts a diagram of social gifting services 140 in accordance with one embodiment of the present invention. In the depicted embodiment, social gifting services 140 resides on retail server 50. FIG. 2B provides an illustration of one embodiment and does not imply any limitations with regard to the environments in which different embodiments may be implemented.

Social gifting services 140 operates to store information relevant to gift giving and gift giving occasions, and to cause reminders and recommendations to be sent about stored gift giving occasions and inferred potential gift giving occasions. Social gifting services 140 may also operate to cause purchases to be sent to contacts, according to information retrieved from their respective contact aggregate, when a user elects to purchase a gift for all of the members of a particular group, wherein the group is defined by a relationship axiom, or an inferred relationship. Inferred relationships may be determined by accessing interoperable social services 120, relationship association function 230 and/or relationship ontology file(s) 240.

In the depicted embodiment, social gifting services 140 includes gifting occasion function 260, buy gift for relationship function 275, and social gifting event storage 270. Social gifting services 140 may include additional software and components not shown.

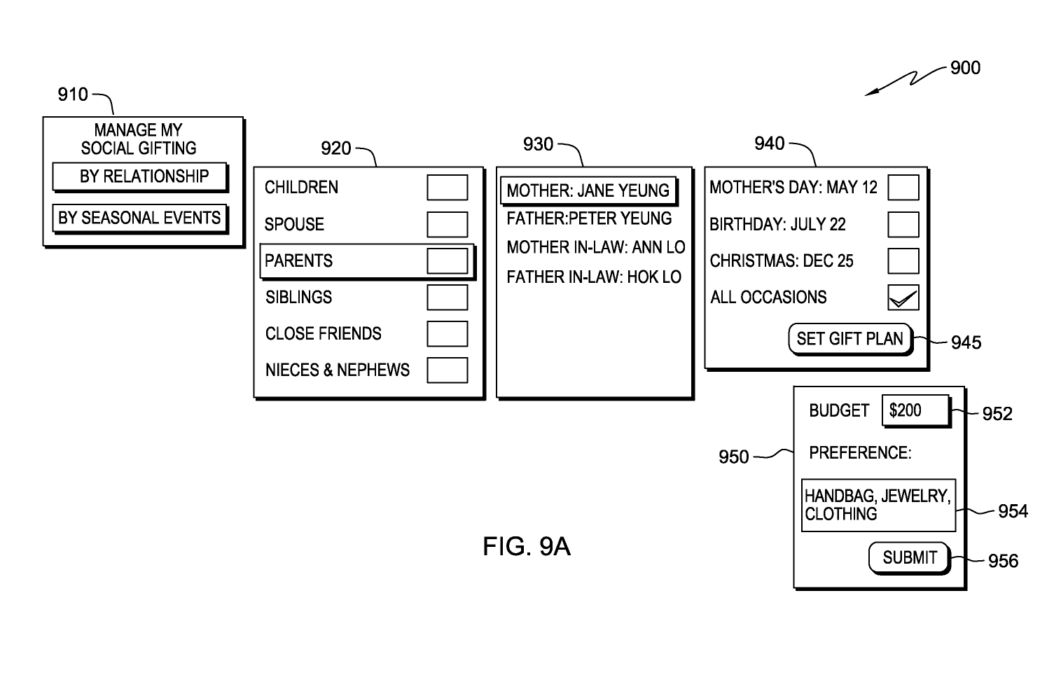

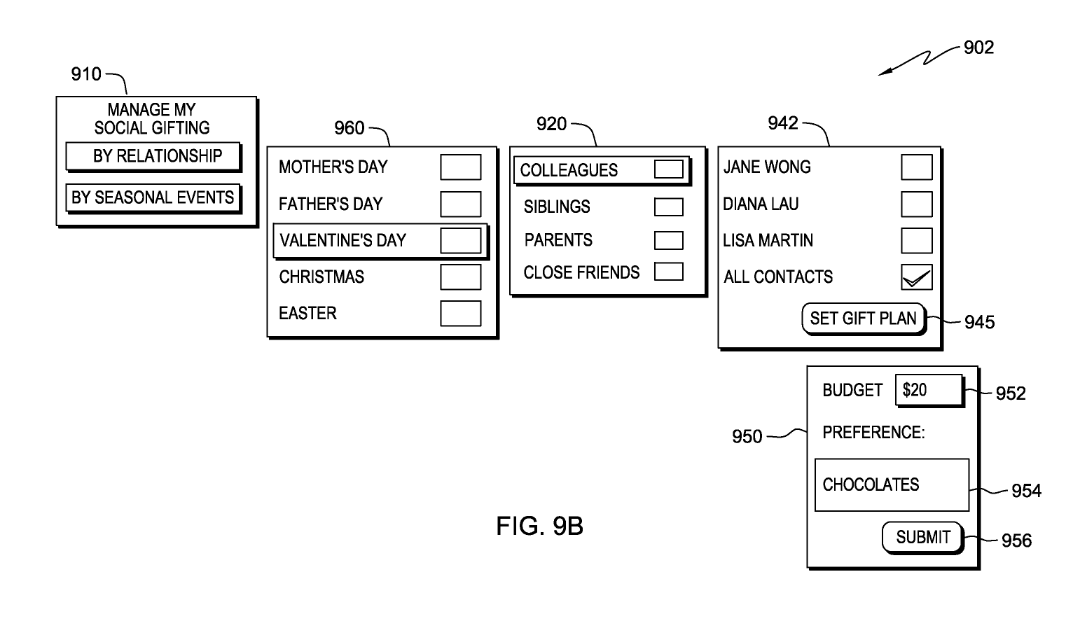

Gifting occasion function 260 operates to cause reminders to be sent to users with regards to upcoming gifting occasions, and/or to cause recommendations for gifting occasions to be generated by providing retail services 130 with budget, relationship, interest and other information. In one embodiment, gifting occasion function 260 retrieves the information from the contact source, such as social networking server 60. In another embodiment, contact aggregation function 220 stores the information to a file accessible by gifting occasion function 260, such as social gifting event storage 270. In one embodiment, contact aggregation function 220 may store the information as a corresponding link to information about that contact, wherein the link to information may be directed to the source of the information, or to the stored information. Gifting occasion function 260 may allow a user to input reminders in a variety of ways. For example, a user may be able to input reminders according to the exemplary user interfaces shown in FIGS. 9A and 9B. A user may be able to input reminders according to seasonal gifting occasions, by selecting contact aggregates, or groups of contact aggregates for a particular holiday. For example, a user may select a group of individuals associated with the relationship axiom “coworker” to setup a gift reminder for Valentine's Day. A user may also be able to input gifting reminders for an individual, and then select the gift giving occasions from which to be reminded. In an exemplary embodiment, information gathered by contact aggregation function 220, retrieved, or otherwise input, can contribute to available gift giving occasion selections within the UI. For example, personal dates that are relevant to gift giving such as anniversaries, birthdays, and graduations, may be automatically associated with the contact aggregate based upon relationship, factual, or other information previously obtained.

In one embodiment, gifting occasion function 260 communicates with relationship association function 230 to make inferences based on relationship associations and cause a user to be queried about additional holidays based upon the relationship or an inferred relationship. For example, if a contact aggregate has an associated relationship of “wife” with another contact, and in addition has one or more associated contact relationships designating a “child,” “son,” or “daughter,” and the second Sunday of May is approaching, gifting occasion function 260 may use relationship association function 230 to infer that the contact “wife” is also a mother, and gifting occasion function 230 may cause the user to be queried as to gifting plans for their wife on mothers day. Gifting occasion function 260 may be able to access gifting schedule information from social gifting event storage 270 to store information. Alternatively, gifting occasion function 260 may be able to access a social networking platform, such as social networking server 60, to gather relevant information or obtain public or private wish lists of potential gift recipients.

Buy gift for relationship function 275 operates to cause contact aggregates or groups of contact aggregates to be retrieved in response to information entered by a user when trying to make a purchase using retail services, such as retail services 130 of retail server 50. Buy gift for relationship function 275 may cause groups of contact aggregates to be retrieved according to associated relationship axioms or inferred relationships using associated relationship axioms and relationship association function 230. Exemplary embodiments of buy gift for relationship function 275 will retrieve contact information, such as phone numbers, email addresses, and shipping addresses of selected gift recipients and provide the information to the user for confirmation and shipping. Buy gift for relationship function 275 may also allow a user to remove contact aggregates from the list of gift recipients to account for errors or specific preferences.

Social gifting event storage 270 is a repository that may be written and read by gifting occasion function 260 and buy gift for relationship function 275. Gifting reminders, budgets, seasonal gifting events, individual gifting dates (e.g., anniversaries, birthdays, etc.), previously purchased gifts, gift recipient interests, and other information may be stored to social gifting event storage 270. In one embodiment, social gifting event storage 270 resides with interoperable social services 120 on retail server 50. In other embodiments, social gifting event storage 270 may reside on another server or another computing device, provided that social gifting event storage 270 is accessible to social gifting services 140, gifting occasion function 260, buy gift for relationship function 275, and retail services 130.

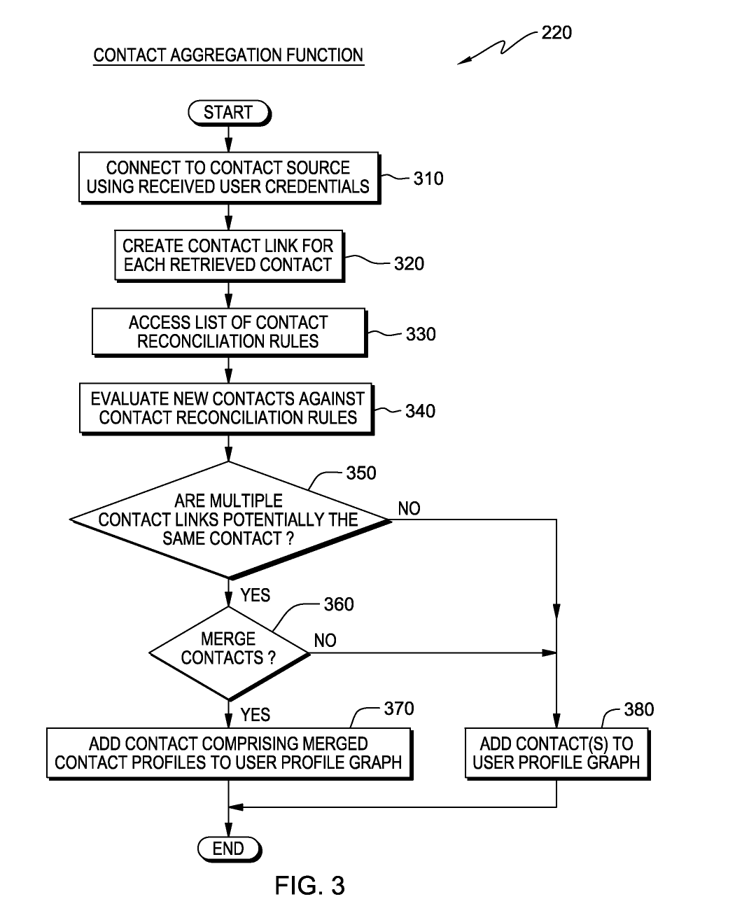

FIG. 3 depicts a flowchart of the steps of contact aggregation function 220 executing within the computing system of FIG. 1, for retrieving information from the user's identified social networking sources in order to determine one or more social networking sources, such as social networking server 60, to interoperate with for the user. Contact aggregation function 220 executes within the computing system of FIG. 1, for retrieving contacts from one or more social networking sources, and merging profiles directed toward the same contact into a single contact aggregate, in accordance with one embodiment of the present invention. Embodiments of contact aggregation function 220 may additionally allow a user to specify information relevant to gifting occasions, such as holidays to give gifts, contact recipients, budgets, gift preferences, and other information.

In one embodiment, a user may have accounts with one or more email, social network, or other networking platform. For example, a user might have profiles with a professional network, a social network, and two email addresses, wherein each account has a contact list or set of connections to other users. A user at client computing device 30 may wish to use these connections to accomplish tasks and use services such as retail services 130 on retail server 50 outside of the confines of the applicable social networking platform(s).

A user may wish to enable interoperable social services that will allow multiple retail or other servers to take advantage of information available to the user through their established profiles and connections on existing email and social networking programs, web sites, and/or other platforms. A user at client computing device 30 may initiate interoperable social services by accessing a server with interoperable social services capabilities. In one embodiment, interoperable social services, such as interoperable social services 120 may have an interface integrated within a web site or application, such as an online retail web site or application. For example, an online retail web site may have a tab or link labeled “manage my social network” that contains access to services provided by interoperable social services 120. A user at client computing device 30 may initiate contact aggregation function 220 through UI 110 by selecting a contact source, such as a social networking, professional networking, email, or other networking platform and inputting necessary information to allow contact aggregation function 220 to gain access to the selected contact source.

Information required to gain access to a contact source may include a username, email address, password, site address, or other information. For example, if the contact source comes from an email account, the account type (e.g., POP3, IMAP, etc.), incoming mail server and outgoing mail server (SMTP) information, and other information may additionally be necessary to allow contact aggregation function 220 the necessary access. Some embodiments of the present invention may be integrated into a contact source program, web site, or platform, and may not require additional user credential information to access the account or profile. In one embodiment, interoperable social services 120 may be integrated within a retail server and fully accessible to retail services, such as retail services 130. In some embodiments, the user may be able to provide contact aggregation function 220 with access to particular connections or group of connections within the selected contact source, rather than provide access to information on all of the connections in entirety.

Once contact aggregation function 220 has the necessary information required to access the contact source(s), in step 310, contact aggregation function 220 connects to the contact source using the received user credentials. For example, the contact source may be a social networking platform run on social networking server 60, and the required user credentials may include the web site of the social networking platform, the user's username, and the password associated with the account.

In step 320, contact aggregation function 220 creates a contact link for each retrieved contact. A contact link may be a URL directed to the contact or user profile source. Additional information about the contact may be stored or URL addressable, such as facts about the contact listed in the profile, listed contact information, profile pictures, important dates (e.g., birthday, anniversary), and relationship information (e.g., spouse, parents, siblings, children, etc.). Some embodiments may extract all information available through the user credentials and store the complete set of information. Other embodiments may merely store links to the particular contact. Contact information and/or links may be stored to a file or database, such as information storage 250.

Contact information may be retrieved from the contact source through the use of an application programming interface (API). In some instances, a social media website or other similar platform may provide an API. An API is intended to be used as an interface by software components to communicate with each other. Many social media platforms provide services with a corresponding API. If a social media website or other similar platform uses an API, contact aggregation function 220 may be able to call the API for specific contact details and other information, rather than relying on other processes.

If a social media platform does not use API, an embodiment of contact aggregation function 220 may be able to use text analytics processes to extract information about contacts. In one embodiment, contact aggregation function 220 uses text analytics to parse through all available contact information and extract information based on keywords or common themes within the text of the user profile of the contact. Text analytics can be performed using an Unstructured Information Management Architecture (UIMA) application configured to analyze unstructured information to discover patterns relevant to contact aggregation function 220 by processing plain text and identifying entities or relations.

In step 330, contact aggregation function 220 accesses a list of one or more contact reconciliation rules from information storage 250. Contact reconciliation rules may help contact aggregation function 220 determine whether profile information from different contact sources is directed to the same user. In some embodiments, the one or more contact reconciliation rules may be a set of default rules. In other embodiments, the one or more contact reconciliation rules may be a customized set of contact reconciliation rules created by a user for resolving whether or not profile information from different contact sources is directed at the same contact. For example, a contact reconciliation rule may state that contact aggregation function 220 should recognize a conflict if two profiles from different social network or other sources share the same birthday. In another example, a contact reconciliation rule may state that contact aggregation function 220 should recognize a conflict if the first and last initial of a user matches that of another user on another social networking platform. In yet another example, a contact reconciliation rule may state that contact aggregation function 220 should recognize a conflict if the first and last name of a user match within a certain specified threshold to that of another user on another social networking platform according to a Levenshtein distance algorithm. The Levenshtein distance between two words is the minimum number of single-character edits (e.g., insertions, deletions, substitutions) required to change one word into the other. In yet another embodiment, a contact reconciliation rule may determine a conflict by using facial recognition software to compare profile pictures from two or more contact sources. In one embodiment, contact reconciliation rules may allow contact aggregation function 220 to automatically determine whether or not user profiles from different contact sources are operated by the same person. In another embodiment, contact aggregation function 220 may alert a user at client computing device 30 when a conflict exists within profiles that have been determined to be the same user, such as when a user lists two different mailing addresses.

In step 340, contact aggregation function 220 evaluates newly retrieved contacts against previously stored contacts according to a set of contact reconciliation rules. If no new contact sources have been added to the user profile graph, there may be no conflicts. However, if there are multiple contact sources, contact aggregation function 220 may compare newly retrieved contacts to those linking or directed to other contact sources which are a part of the user profile graph. In one embodiment, contact aggregation function 220 individually selects each contact or contact link and compares it to stored contacts from other sources according to the applicable contact reconciliation rules (see step 320). Embodiments of contact aggregation function 220 may select new contacts to be evaluated by username or any other organized method.

In decision 350, contact aggregation function 220 determines whether two or more contacts or contact links from different contact sources are potentially directed to the same contact (i.e., the same user operates each profile in question). If contact aggregation function 220 determines that the contact is not directed to the same user as another contact from another contact source (decision 350, no branch), contact aggregation function 220 adds the contact link to the user profile graph (step 380) and stores the information to a file or database, such as information storage 250. In one embodiment, contact aggregation function 220 may store additional information extracted from the contact source to a file or database, such as information storage 250. If there are additional contact sources to input, contact aggregation function 220 may repeat the process for each additional contact source.

If contact aggregation function 220 determines that the contact is potentially directed to the same user as another contact from another contact source (decision 350, yes branch), contact aggregation function 220 may determine whether or not to merge the two contacts into a single user profile graph object, or a single contact providing access to both contact sources (decision 360). In some embodiments, contact aggregation function 220 may automatically make this determination (decision 360) based on the evaluation of the contacts using the list of one or more contact reconciliation rules (see steps 330-350). In other embodiments, contact aggregation function 220 may notify the conflict to the user, through a computing device, such as client computing device 30. For example, if there is a conflict, contact aggregation function 220 may cause the two profiles to be displayed on the user interface of the retail site or application and contact aggregation function 220 may cause the conflict to be displayed to the user through client computing device 30. Contact aggregation function 220 may then query the user for a determination on whether to merge the contacts. In either embodiment, if contact aggregation function 220 determines that the contacts should not be merged (decision 360, no branch), contact aggregation function 220 adds the contact link to the user profile graph (step 380) and stores the information to a file or database, such as information storage 250. In one embodiment, contact aggregation function 220 may store additional information extracted from the contact source to a file or database, such as information storage 250. If there are additional contact sources to input, contact aggregation function 220 may repeat the process for each additional contact source.

If contact aggregation function 220 determines that the contacts should be merged (decision 360, yes branch), contact aggregation function 220 will merge the information into a single contact aggregate, and add the contact aggregate for storage as a part of the user profile graph (step 370). Merging contacts may comprise including multiple contact links for a single contact, wherein each contact link is directed at a different contact source (e.g., email, social network, professional network, etc.). In some embodiments, contact aggregation function 220 may extract information from the contact source to be stored. In such an embodiment, contact aggregation function 220 may store extracted information under a single contact, contact aggregation function 220 may delete duplicate information, and contact aggregation function 220 may alert a user at client computing device 30 as to any information that does not match (e.g., different birthdays listed, different geographic locations, etc.) and may allow the user to specify the conflicting information to consider as primary. In some embodiments, alerts may be displayed within the user interface of retail services 130. Contact aggregation function 220 may store the information to a file or database, such as information storage 250. In one embodiment, contact aggregation function 220 may store additional information extracted from the contact source to a file or database, such as information storage 250. If there are additional contact sources to input, contact aggregation function 220 may repeat the process for each additional contact source.

Contact aggregation function 220, or another function of social services program 210 may allow a user to select primary contact methods for a contact, such as a contact added to the user profile graph. For instance, a contact may contain one or more email addresses, telephone numbers, social network usernames, or other methods by which the contact may be accessed, and a user may be aware of how the user prefers to be contacted. In such a scenario, social services program 210 may allow the user to specify messaging preferences for individual contacts, and store those preferences to a file or database, such as information storage 250.

In some embodiments, a function of social services program 210, such as contact aggregation function 220, may allow a user to store gifting information. Gifting information may include reminders for holidays, birthdays, anniversaries, or other gift giving events. Gifting information may also include set budgets for contacts or groups of contacts to assist in gift occasion planning. Gifting information may also include a required relationship between a user and one or more contacts or contact aggregates. A user may be able to set a gifting threshold that would notify a function, such as gifting occasion function 260 of social gifting services 140, as to when a reminder should be sent for a particular gift giving occasion. Interests of potential gift recipients may be collected via user input or contact aggregation function 220 retrieval to enhance the results of an algorithm of retail services 130 that provides relevant gift recommendations. In one embodiment, interests of a potential gift recipient may be previously stored as interest information, wherein the interest information may include hobbies, favorite music, liked pages, or other information that may indicate an interest of the contact. Gifting information may also include gifts previously given to a gift recipient. By storing gifts previously given to a gift recipient, products will not be recommended twice when purchasing for the same contact aggregate gift recipient, and previously purchased items for the contact aggregate may be used to enhance gifting recommendations and promotional suggestions. In general, gifting information may include any information relevant to the process of buying an individual a gift for an occasion. Gifting information may be stored to a file or database, such as social gifting event storage 270. Gifting information may be accessible to gifting occasion function 260, retail services 130, contact aggregation function 220, and relationship association function 230.

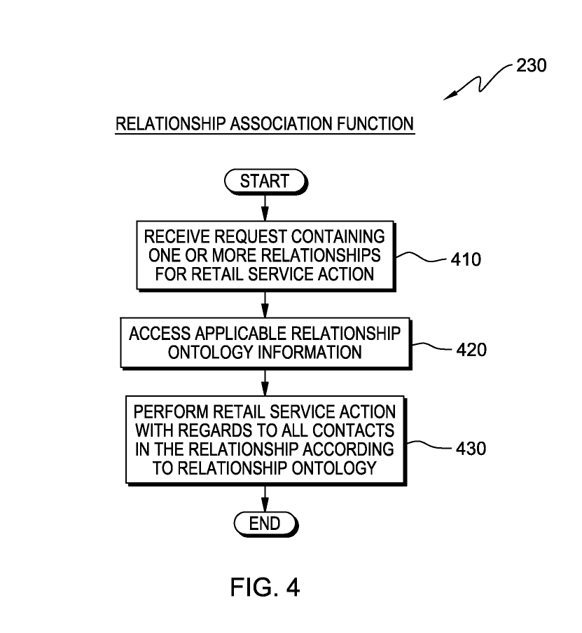

FIG. 4 depicts a flowchart of the steps of relationship association function 230 executing within the computing system of FIG. 1, for assisting in the performance of retail services by using contact aggregates to enhance retail actions, and associating relationship axioms with contact aggregates, in accordance with one embodiment of the present invention. In some embodiments, relationship association function 230 may assist retail service action performance by using and providing access to associated relationship axioms among contacts, and/or inferences determined from associated relationship axioms to determine membership of contact aggregates within a queried relationship.

In one embodiment, initially, a user at client computing device 30 may use UI 110 to connect to a server, such as retail server 50, and extract contact information from identified sources of social networking. At any point after generating such a group of contact aggregates and associating relationship axioms, the user may use the connection to the server, such as retail server 50, to gain access to retail services, such as retail services 130. Retail services 130 may be any type of online retail services offered by an online retailer or other merchant. For example, retail services 130 may include auctioning goods or services, buying or selling goods or services, creating and sharing wish lists, browsing catalogs or recommendations, posting customer reviews, or engaging or utilizing any other type of online retail service. Assuming retail server 50 has installed or otherwise has access to interoperable social services 120, relationship association function 230 may be used, by referencing relationships, either associated or indirect, as a part of the usage of retail services. For example, a retail service “shopFor” may take “sibling” as a parameter for a user such that the item(s) that the user purchases with the retail service “shopFor” will be delivered to all of his or her siblings.

In step 410, relationship association function 230 receives a request to assist retail services 130 perform a retail service action. For example, the request to retail services 130 may be “buy and deliver one copy of ‘book’ to each one of my brothers.” Retail services 130 may request that relationship association function 230 return contact information for the members of the group “brothers.” The relationship specified may be a relationship that was specifically designated by a user; however, it may also be a relationship that must be inferred by relationship association function 230. For instance, if a user has designated a contact as their brother, an inference could be made by relationship association function 230 that the user's brother is also a sibling. Such an inference may be made by accessing relationship ontology information.

When a specified relationship is not one which has been specifically designated, but rather one that relationship association function 230 must infer, relationship association function 230 may access applicable relationship ontology information (step 420). Relationship ontology information may be stored to files or databases, such as relationship ontology file(s) 240. In exemplary embodiments, relationship ontology file(s) 240 are URL addressable and may be accessed by any user, computing device, or entity with access to the internet. In some embodiments, relationship ontology file(s) 240 may be stored using the web ontology language (OWL). OWL is a format that can be used to define an ontology. OWL can define relatively rich semantics including relations between classes of entities, properties, and characteristics of properties. Relationship ontology information may be used to describe any types of relationships, such as the relationship previously described, and enterprises may include additional ontology files in order to enhance their service offerings. For example, a familial relationship ontology file may include that a mother is a parent, immediate family member, relation, woman, has child, etc. Relationship association function 230 may use such details to make inferences based on disclosed relationships.

In step 430, relationship association function 230 causes the retail service action requested to be performed with regards to all contacts within the group that comprises the specified relationship. Contacts in the specified relationship may be based on specifically designated relationships, or relationships inferred by relationship association function 230, wherein the relationship association function 230 inferred the relationships by accessing applicable relationship ontology file(s) (see step 420). In some embodiments, the retailer or other merchant performing the retail service or action may use contact information located on a previously created user profile graph, containing links to contact sources, to request that relationship association function 230 connect to the contact source, using received user credentials, and retrieve information in a similar manner as discussed with regards to contact aggregation function 220 and FIG. 3. For example, retail services 130 may include retail services such as sending a package to a desired contact or set of contacts, and relationship association function 230 may connect to the contact source to verify that the address information for a particular contact is current. In another example, the service action may include sending a wish list to all immediate family, and relationship association function 230 may connect to the contact source, such as social networking server 60, to find contacts in the group “immediate family” and cause a wish list to be sent to the contacts within the group. In one embodiment, relationship association function 230 may retrieve relationship and contact information stored to information storage 250 using a SPARQL protocol and RDF query language (SPARQL) query. A SPARQL query allows for retrieval of data stored in resource description framework (RDF) format. RDF format allows for a method for conceptual description or modeling of information that is implemented in web resources, using a variety of syntax notations and data serialization formats.

In one embodiment, relationship association function 230 may also be used to transfer groups of contacts, or entire lists of contacts, such as those included within a user profile graph, and stored to information storage 250. Relationship association function 230 may transfer contacts and/or contact information from one retail server to another retail server, assuming both retail servers are equipped with interoperable social services. For example, a user may have input contacts using interoperable social services 120 on retail server 50, and may desire to take advantage of other retail services, such as those offered by another retailer on another server. In some embodiments, the user may direct relationship association function 230 to transfer all of, or a selection of the user profile graph, or other stored contact information to a substantially similar duplicate of interoperable social services 120, located on another retail server. In one embodiment, a user may specify a group of contacts to be transferred, such as family, friends, neighbors, or co-workers.

A function of social services program 210, such as relationship association function 230 may allow a user to define relationships between contacts, groups of contacts, and the user. Relationship association function 230 may allow a user to define familial (e.g., brother, parent, cousin), employment (e.g., boss, co-worker, business partner), service (e.g., barber, lawyer), geographic (e.g., neighbor, lake house), and other types of relationships between the user and contact, or between contacts themselves. In one embodiment, a user at client computing device 30 may be able to define such relationships through UI 110 via a connection to interoperable social services, such as interoperable social services 120 across network 20. In one embodiment, contact aggregation function 220 may be able to extract relationship-type information that has already been established by a user on the social network or other contact source platform or site. Relationships information may be stored as a part of the user profile graph, or with other extracted contact information. Relationships may be stored to a file or database, such as information storage 250. Relationships and relationship information may be accessible to relationship association function 230 and social services program 210.

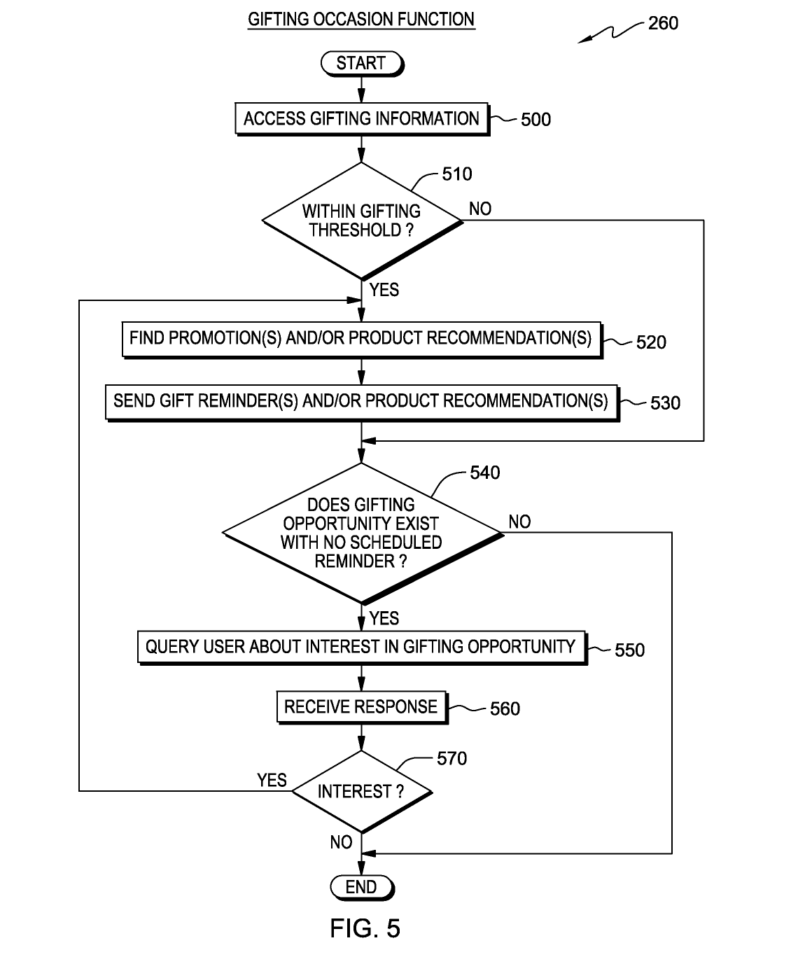

FIG. 5 depicts a flowchart of the steps of gifting occasion function 260 executing within the computing system of FIG. 1, for causing gifting reminders and gifting suggestions and/or product recommendations to be sent to users, in accordance with one embodiment of the present invention. In some embodiments, gifting occasion function 260 also allows a user to input gifting reminder information according to relationship or seasonal holidays. Exemplary user interfaces for inputting gifting reminders are shown by FIGS. 9A and 9B.

Initially, a user may access retail server 50 and use contact aggregation function 220 to retrieve contact and profile information from one or more social networking platforms, such as social media web sites or professional networking platforms. A user may also associate relationship axioms between contact aggregates or groups of contact aggregates and/or between the user and one or more of his or her contact aggregates. As previously mentioned, a function of interoperable social services 120, such as contact aggregation function 220 or gifting occasion function 260, may allow a user to specify gifting information via client computing device 30, using UI 110. Gifting information may include budgets, gifting reminders, gift recipient interests and preferences, and other gift giving related information. An interface may be integrated within the web site or application that provides retail services, such as retail services 130, to allow a user to input gifting information. For example, holidays and other gift giving occasions may be pre-stored and a user may select which occasions they would like to be reminded about, and the contact aggregates to which that they plan to send gifts. In addition, birthdays, anniversaries, or other relational holidays (e.g., mother's day, father's day) may be added for specified contact aggregates. Such an integrated interface may further include the ability to set a budget for individual contact aggregates or groups of contact aggregates for each gift giving occasion. Additionally, the interface may allow the user to set a gifting threshold. A gifting threshold is a time period before the gifting occasion (i.e., a week, a month, etc.) whereby the gift giving user would prefer to be reminded of the upcoming gifting occasion, and/or presented with one or more promotions and product recommendations for the gift giving occasion. In some embodiments, a gifting threshold may dictate particular brands, goods, or promotional items desired by a contact aggregate, so that relevant promotional information may be distributed during different times of the year. In some embodiments, contact aggregation function 220 may gather information relevant to gifting, such as important dates (e.g., birthday, anniversary), interests, relationships, religions (e.g. Christian—Christmas, Jewish—Chanukah), and locations. All gathered gifting information, both user-input and automatically retrieved, may be stored to a file or database, such as social gifting event storage 270.

Gifting occasion function 260 may run periodically, or in other embodiments, may run according to preferences established by the user, owner of the account, or administrator of the retail server, such as the administrator of retail server 50.

In step 500, gifting occasion function 260 accesses gifting information. In some embodiments, gifting information may be stored to a file or database, such as social gifting event storage 270. In some embodiments, gifting information may link to social media, professional networking, email, or other networking platforms and gifting occasion function 260 may access these contact sources according to the methods discussed in step 310 of contact aggregation function 220 (see FIG. 3).

As previously discussed, gifting information may include gifting threshold information. Gifting threshold information provides a date or time period before a gift giving occasion, whereby the user has requested a reminder or gift recommendation. In decision 510, gifting occasion function 260 determines whether the current date or time, as of the running of the function, is within any gifting thresholds.

If gifting occasion function 260 determines that the current date or time is within at least one gifting threshold (decision 510, yes branch), gifting occasion function 260 uses gifting information to find applicable promotions and/or product recommendations for the gift giving occasion (step 520). In some embodiments, gifting occasion function 260 may provide information to retails services 130 and request that retail services 130 generate recommendations using the information provided. In some embodiments, rather than a date and time, a gifting threshold may be related to a particular brand, item, or area of interest and a user may be notified when sales or promotions exist that match stored information. Gifting occasion function 260 may determine that the current date or time is within at least one gifting threshold by searching through gifting threshold information stored to social gifting event storage 270. In some embodiments, gifting occasion function 260 may cause retail services 130 to use an algorithm to suggest gifts. Gifting occasion function 260 may use interests, preferences, and previously purchased gifts for a user to enhance the recommendations offered by retail services 130. Gifting occasion function 250 may have access to contact sources through information contained in social gifting event storage 270 that may further assist in enhancing the recommendations offered by retail services 130. Once a set of recommendations has been formed, gifting occasion function 260 causes all applicable gift reminders and recommendations to be sent to the user (step 530). Gift reminders and recommendations may be sent to users via email, text, mail, or any other method of communication. In some embodiments, a user may customize the means by which they will receive gift reminders and recommendations.

After completing the previous steps, or if gifting occasion function 260 determines that the current date or time is not within at least one gifting threshold (decision 510, no branch), gifting occasion function 260 determines whether an upcoming gifting opportunity exists that does not currently have a scheduled reminder. Gifting occasion function 260 may determine whether an unscheduled upcoming gifting opportunity exists by comparing preset holidays and gift giving occasions with stored relationships and personal gifting dates. In some embodiments, gifting occasion function 260 may utilize relationship association function 230 to determine whether an unscheduled gifting opportunity exists. For example, a user may have a wife and children, and gifting occasion function 260 may use relationship association function 230 to infer that the wife is a mother, and recommend that she receive a gift for Mother's Day. If gifting occasion function 260 determines that a currently unscheduled gifting opportunity does not exist, the function is complete.

If gifting occasion function 260 determines that a currently unscheduled gifting opportunity does exist (decision 540, yes branch), gifting occasion function 260 may cause a query to be sent to the user about the gifting opportunity that asks if the user would like gifting recommendations for the potential gifting event (step 550). Gifting occasion function 260 may cause the query to be sent to the user via an email, text message, instant message, or any other communication method. Communication preferences for such a query may be established by the user or an administrator of a retails server, such as the administrator of retail server 50. In some embodiments, the query will contain product recommendations, promotions, or other information, and such information may be generated by information provided and/or retrieved about the potential gift recipient contact aggregate.

In step 560, gifting occasion function 260 receives a response to the query of step 550. Based on the received response, gifting occasion function 260 determines whether there is received interest in the currently unscheduled gifting opportunity. If gifting occasion function 260 determines there is not interest in the currently unscheduled gifting opportunity (decision 570, no branch), the gifting opportunity will remain unscheduled, and the function is complete. In some embodiments, gifting occasion function 260 will store information so that it does not continue to suggest declined unscheduled gifting opportunities in the future.

If gifting occasion function 260 determines that there is interest in the currently unscheduled gifting opportunity (decision 570, yes branch), gifting occasion function 260 may cause retail services 130 to find promotions and/or product recommendations (step 520), unless this step has already been performed, and may cause gift recommendations to be sent to the user (step 530). Gifting occasion function 260 will then continue, as previously discussed, until the process is complete. In some embodiments, gifting occasion function 260 may store information about the new gifting opportunity, so as to send additional reminders for that or similar gifting opportunities in the future.

In some embodiments, a function of social gifting services 140, such as gifting occasion function 260, may allow a user to store gifting information. Gifting information may include reminders for holidays, birthdays, anniversaries, or other gift giving events. Gifting information may also include set budgets for contacts or groups of contacts to assist in gift occasion planning. As previously discussed, a user may be able to set a gifting threshold that would notify a function, such as gifting occasion function 260 of social gifting services 140, as to when a reminder should be sent for a particular gift giving occasion. Interests of potential gift recipients may be collected via user input or contact aggregation function 220 retrieval to enhance the results of an algorithm of retail services 130 that provides relevant gift recommendations. Gifting information may also include gifts previously given to a gift recipient. By storing gifts previously given to a gift recipient, products will not be recommended twice when purchasing for the same contact aggregate gift recipient, and previously purchased items for the contact aggregate may be used to enhance gifting recommendations and promotional suggestions. In general, gifting information may include any information relevant to the process of buying an individual a gift for an occasion. Gifting information may be stored to a file or database, such as social gifting event storage 270. Gifting information may be accessible to gifting occasion function 260, retail services 130, contact aggregation function 220, and relationship association function 230.

FIG. 6 is an exemplary user interface window to a contact aggregation function in accordance with one embodiment of the present invention. User interface window 600 may be a user interface within contact aggregation function 220 of retail server 50 of FIG. 1, as accessible to a user through UI 110 at client computing device 30. User interface window 600 allows a user to associate relationships between the user and one or more contact aggregates from their list of contact aggregates, as created by contact aggregation function 220. In the depicted embodiment, user interface window 600 is shown as viewed by a user from an online account management page of an online retail site, such as an online retail site hosted by retail server 50.

User interface window 600 contains manage my social network relationship(s) tab 610, contact aggregate 620, list of contact aggregates 630, add relationship button 640, contact aggregate details 650, and relationship selection fields 660. User interface window 600 may contain manage my social network relationship(s) tab 610. Manage my social network relationship(s) tab 610 may be a selection tab added to a retail site, such as the retail site that provides retail services 130 and is hosted by retail server 50. Manage my social network relationship(s) tab 610 may provide a user with access to their list of contact aggregates, as created by a contact aggregation function, such as contact aggregation function 220 of retail server 50. Alternatively, the list of contact aggregates may have been imported from another server or computing device containing interoperable social services 120. Manage my social network relationship(s) tab 610 may allow a user to view details of individual contact aggregates. Manage my social network relationship(s) tab 610 may also allow a user to define relationships between the user and one or more contact aggregates.

User interface window 600 contains list of contact aggregates 630. List of contact aggregates 630 contains the list of contact aggregates for the user, as created by a contact aggregation function, such as contact aggregation function 220 of retail server 50. The depicted user has selected contact aggregate 620. Here, contact aggregate 620 is Joe Smith. When a contact aggregate, such as contact aggregate 620 is selected in the current embodiment, details of the selected contact aggregate are displayed in aggregate details 650.

Aggregate details 650 may contain previously gathered, or currently accessible information about the contact aggregate. In the depicted embodiment, aggregate details 650 includes contact aggregate Joe Smith, as well as a phone number and address for Joe Smith. In some embodiments, different or additional information about the contact aggregate may be shown. In some embodiments, multiple contact aggregates may be selected from list of contact aggregates 630, and details for each contact aggregate may be shown in aggregate details 650.

Aggregate details 650 may also contain add relationship button 640. Add relationship button 640 allows a user to define relationships between the user and one or more contact aggregates. In other embodiments, add relationship button 640 may allow a user to define relationships between contact aggregates, as compared to one another.

Relationship selection fields 660 allow a user to select from a number of relationships. In one embodiment, the displayed relationships will be based upon identified relationships in applicable relationship ontologies, such as relationship ontologies stored to relationship ontology field(s) 240. Based on the gender, age, or other information gathered, the displayed relationships may vary. In some embodiments, a user may be able to input their own relationship, or search for additional relationships. In the current depiction, the user has established that Joe Smith is his brother by selecting the box next to brother.

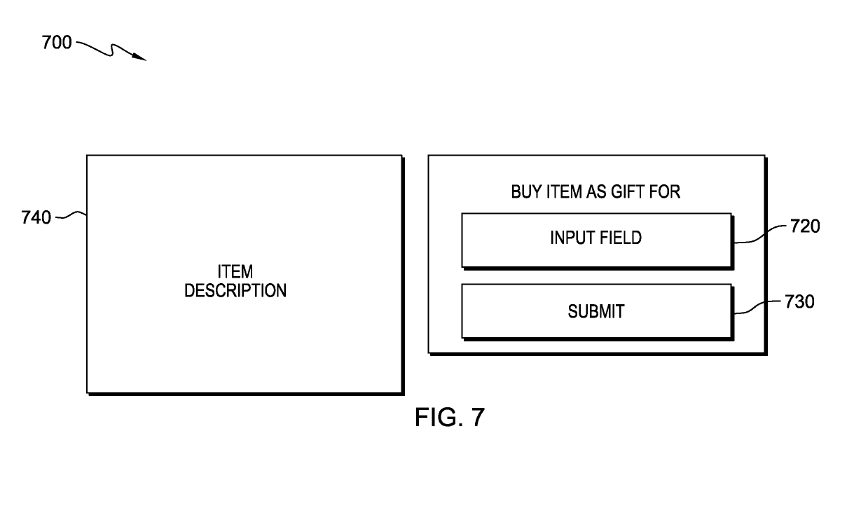

FIG. 7 is an exemplary user interface window of a retail website with access to interoperable social services 120 and social gifting services 140. User interface window 700 may be a user interface window for accessing retail services, such as retail services 130 of retail server 50 of FIG. 1. User interface window 700 may be a user interface window with enhanced capabilities caused by buy gift for relationship function 275. User interface window 700 allows a user to purchase items on a retail website for contacts, by inputting the contact aggregate, a previously associated relationship, or a relationship that can be inferred by accessing relationship association function 230.

User interface window 700 contains item description 740, input field 720, and submit button 730. Item description 740 contains information related to the item the user is currently browsing. Such information might include the product name, description, size, weight, reviews, and other such information relevant to retail shoppers. Input field 720 allows a user to input a contact aggregate or relationship. For example, a user may input “siblings” into input field 720 and doing so may cause relationship association function 230 to find all members within the group “siblings.” In some embodiments, when a relationship is input into input field 720, the members of that relationship group will be immediately displayed. Submit button 730 will place the item in the shopping cart of the user or will proceed to the next step for purchase.

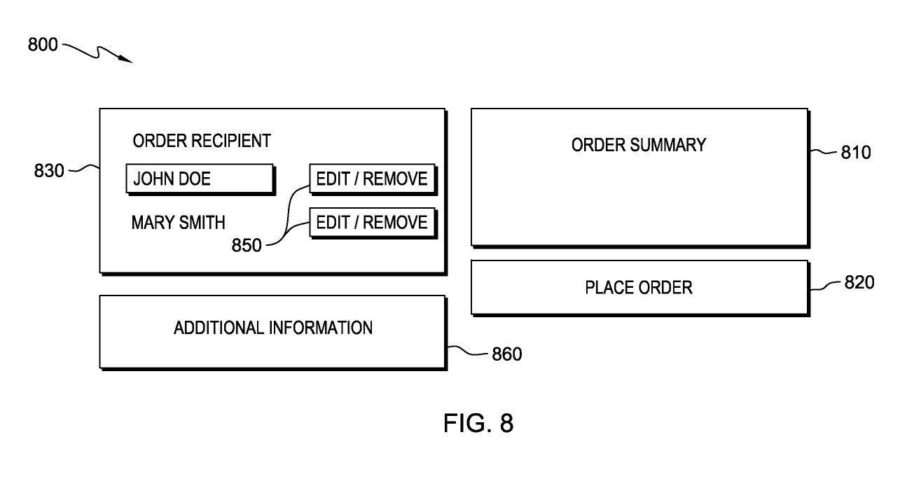

FIG. 8 is an exemplary user interface window of a retail website with access to interoperable social services 120 and social gifting services 140. User interface window 800 may be a user interface for accessing retail services, such as retail services 130 of retail server 50 of FIG. 1. User interface window 800 allows a user to finalize purchase decisions, view contact aggregates that are to receive the selected purchase, and place an order for the purchase.

User interface window 800 contains order summary 810, place order button 820, order recipient(s) list 830, control button(s) 850, and additional input fields 860. Order summary 810 may display order summary information, such as total charges, products in shopping cart, or product descriptions. Order recipient(s) list 830 may include the contact aggregates selected via name or relationship from within user interface window 700 of FIG. 7. Control button 850 may allow the user to remove members from order recipient(s) list 830. In some embodiments, control button 850 may allow a user to change information about the recipient, such as the shipping address associated with the contact aggregate or other similar actions. Additional input field 860 may allow a user to input additional information, such as a message from the sender, select an option to gift-wrap the order, or select other shipping preferences. Place order button 820 may allow a user to place their order, or proceed to the next step of the ordering process, with regards to the contact aggregates listed in order recipient(s) list 830.

FIG. 9A is an exemplary user interface window of a retail website with access to interoperable social services 120 and social gifting services 140. User interface window 900 may be a user interface for inputting gifting occasion reminders, setting budgets, and inputting potential gift recipient contact aggregate gift preferences, wherein the menus are first organized according to relationship to the user.

User interface window 900 contains manage my social gifting menu 910, relationship list 920, contact aggregate list 930, gifting occasion list 940, set gift plan button 945, gift plan template 950, budget field 952, gift preferences field 954, and submit button 956. Manage my social gifting menu 910 may allow a user to manage their social gifting reminders, budgets, and preferences by organizing such information according to relationship, seasonal events, or other methods of organization. In the current illustration, the method of organization selected is “by relationship.” Relationship list 920 may be a list that contains relationships, according to previously associated relationship axioms, that the user has with one or more contact aggregates. In the current illustration, the user has selected “parents.” Contact aggregate list 930 lists the contact aggregates that are associated with the previously selected relationship axiom. Here, the parents and in-laws of the user have populated contact aggregate list 930 because the user selected “parents” in relationship list 920. Selecting a contact aggregate from contact aggregate list 930 brings up gifting occasion list 940. Gifting occasion list 940 may contain gift giving occasions that are relevant to the selected contact aggregate based upon extracted and input information (e.g., anniversaries, birthdays, relevant religious holidays), and seasonal gift giving occasions. A user may be able to set reminders for particular gift giving occasions for that contact aggregate by selecting selection boxes for the holidays shown. In some embodiments, a user may be able to input additional reminders and gift giving occasions. A user may be able to set a gift plan for the contact aggregate by selecting set gift plan button 945. Selecting set gift plan button 945 opens gift plan template 950. Within the various fields of gift plan template 950, a user can set a budget for the selected contact aggregate 952, and input gift recipient preferences 954. Gift recipient preferences may include interests, favorite brands, or other information that may enhance recommendations and promotions generated by retail services, such as retail services 130. Selecting submit button 956 will store all input information to a file or database, such as social gifting event storage 270.

FIG. 9B is an additional exemplary user interface window of a retail website with access to interoperable social services 120 and social gifting services 140. User interface window 902 may be a user interface for inputting gifting occasion reminders, setting budgets, and inputting potential gift recipient contact aggregate gift preferences, wherein the menus are first organized according to seasonal gifting occasions.

User interface window 902 contains manage my social gifting menu 910, seasonal gifting occasion list 960, relationship list 920, contact aggregate selection list 942, set gift plan button 945, gift plan template 950, budget field 952, gift preferences field 954, and submit button 956. Manage my social gifting menu 910, relationship list 920, set gift plan button 945, gift plan template 950, budget field 952, gift preferences field 954, and submit button 956 all are organized and operate similar to their discussion in FIG. 9A.

User interface window 902 is organized according to seasonal gifting occasion rather than by relationship (see FIG. 9A). Seasonal gifting occasion list 960 contains gift giving occasions that are historically known as gift giving occasions. In some embodiments, this list may vary depending upon the location of the user, or additionally based upon religious or cultural information input by the user. A user may select a gifting occasion from seasonal gifting occasion list 960, which may open relationship list 920. A user may select a relationship axiom from relationship 920 to open contact aggregate selection list 942. Contact aggregate selection list 942 contains a list of contact aggregates associated with the previously selected relationship axiom. A user may then select potential gift recipient contact aggregates for the selected gifting occasion and fill information into gift plan template 950, similar to the discussion in FIG. 9A.

For all preceding user interfaces, it should be recognized by one skilled in the art, that the preceding examples are merely examples of possible user interfaces. Other user interfaces, organizational methods, and gift planning settings may be applied in accordance with additional embodiments of the present invention.

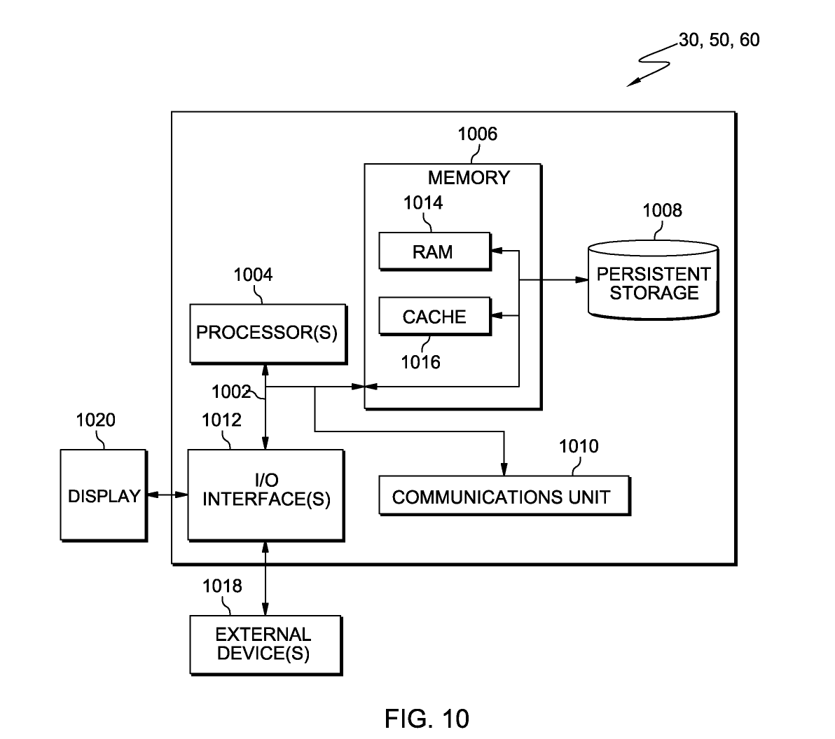

FIG. 10 depicts a block diagram of components of client computing device 30, retail server 50, and social networking server 60 in accordance with an illustrative embodiment of the present invention. It should be appreciated that FIG. 10 provides only an illustration of one implementation and does not imply any limitations with regard to the environments in which different embodiments may be implemented. Many modifications to the depicted environment may be made.

Client computing device 30, online retail server 50, and social networking server 60 each include communications fabric 1002, which provides communications between computer processor(s) 1004, memory 1006, persistent storage 1008, communications unit 1010, and input/output (I/O) interface(s) 1012. Communications fabric 1002 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 1006 and persistent storage 1008 are computer-readable storage media. In this embodiment, memory 1006 includes random access memory (RAM) 1014 and cache memory 1016. In general, memory 1006 can include any suitable volatile or non-volatile computer-readable storage media.

Retail services 130, social gifting services 140, and interoperable social services 120 are stored in persistent storage 1008 of retail server 50 for execution and/or access by one or more of the respective computer processors 1004 of retail server 50 via one or more memories of memory 1006 of retail server 50. In this embodiment, persistent storage 1008 includes a magnetic hard disk drive. Alternatively, or in addition to a magnetic hard disk drive, persistent storage 1008 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 1008 may also be removable. For example, a removable hard drive may be used for persistent storage 1008. Other examples include optical and magnetic disks, thumb drives, and smart cards that are inserted into a drive for transfer onto another computer-readable storage medium that is also part of persistent storage 1008.

Communications unit 1010, in these examples, provides for communications with other data processing systems or devices. In these examples, communications unit 1010 includes one or more network interface cards. Communications unit 1010 may provide communications through the use of either or both physical and wireless communications links. Retail services 130, social gifting services 140, and interoperable social services 120 may be downloaded to persistent storage 1008 of retail server 50 through communications unit 1010 of retail server 50.

I/O interface(s) 1012 allows for input and output of data with other devices that may be connected to computing system 10. For example, I/O interface 1012 may provide a connection to external devices 1018 such as a keyboard, keypad, a touch screen, and/or some other suitable input device. External devices 1018 can also include portable computer-readable storage media such as, for example, thumb drives, portable optical or magnetic disks, and memory cards. Software and data used to practice embodiments of the present invention, e.g., retail services 130, social gifting services 140, and interoperable social services 120, can be stored on such portable computer-readable storage media and can be loaded onto persistent storage 1008 of retail server 50 via I/O interface(s) 1012 of retail server 50. I/O interface(s) 1012 also connect to a display 1020.

Display 1020 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for utilizing social networking services of a user to perform online retail services, the method comprising:
retrieving a set of contacts, wherein the set of contacts includes a first group of contacts of a first networking service and a second group of contacts of a second networking service, wherein each contact in the set of contacts has a corresponding link to information about that contact;
receiving a request for an action to be executed, wherein the request includes gifting information, wherein the gifting information specifies a required relationship between the user and the one or more contacts of the set of contacts;
determining, by one or more processors, the one or more contacts that have the required relationship with the user, as specified by the gifting information; and
causing the action to be executed based on the determined one or more contacts.

2. The method of claim 1, wherein the action to be executed is generating a reminder based on the gifting information.

3. The method of claim 1, wherein the action to be executed comprises:
retrieving interest information from the corresponding link to information about the determined one or more contacts; and
generating a gift recommendation using the interest information retrieved from the corresponding link to information about the one or more contacts.

4. The method of claim 3, wherein the gifting information comprises predefined budget information, and wherein the step of generating a gift recommendation comprises generating a gift recommendation using the predefined budget information and the interest information retrieved from the corresponding link to information about the one or more contacts.

5. The method of claim 1, further comprising:
accessing the corresponding link to information about a first contact of the one or more contacts; and
retrieving a relationship between the first contact and the user, wherein the relationship is associated with a gift giving occasion.

6. The method of claim 5, wherein the action to be executed is generating a reminder for a gift giving occasion based on the gifting information and the retrieved relationship between the first contact and the user.

7. The method of claim 1, further comprising:
determining, by the one or more processors, the required relationship between the user and the one or more contacts of the set of contacts based on at least an associated relationship between the user and a contact of the set of contacts.

8. The method of claim 7, wherein the step of determining, by the one or more processors, the required relationship between the user and the one or more contacts of the set of contacts based on the associated relationship comprises:
accessing ontology information, wherein the ontology information includes a set of concepts used to describe relationships generally; and
determining, by the one or more processors, the required relationship between the user and the one or more contacts of the set of contacts based on the associated relationship as described in the ontology information.
